(19) United States
(12) Patent Application Publication
(10) Pub. No.: US 2008/0279272 A1
(43) Pub. Date: Nov. 13, 2008

(54) Contents reproducing apparatus

(75) Inventors: Tatsunori Saito, Sagamihara-shi (JP); Hirofumi Mori, Koganei-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/005,490

(22) Filed: Dec. 27, 2007

(30) Foreign Application Priority Data
May 10, 2007 (JP) 2007-125871

(51) Int. Cl. H04N 11/04

(52) U.S. Cl. 375/240.01; 375/E07.001

(57) ABSTRACT

A contents reproducing apparatus includes a clock unit configured to count a STC, and output a counter value, a receiving unit configured to receive a packet having an ES containing encoded video data or the encoded audio data, an transport error indicator to be used for detecting an error, and a PTS, and add a counter value as a receipt time at the time of reception, a correcting unit configured to correct the PTS by using the receipt time and an interval from reception of a packet to reproduce of a packet, if the error is detected in the packet, a buffer configured to store the ES and PTS, and a decoder configured to decode the encoded video data or the encoded audio data from the ES and obtain video data or audio data, if the counter value reaches the PTS.

### CROSS-REFERENCE TO RELATED APPLICATIONS

This application is based upon and claims the benefit of priority from prior Japanese Patent Application No. 2007-125871, filed May 10, 2007, the entire contents of which are incorporated herein by reference.

### BACKGROUND OF THE INVENTION

1. Field of the Invention

The present invention relates to an apparatus for reproducing video or audio data transmitted in a transport stream.

2. Description of the Related Art

In digital terrestrial broadcasting received by a 3rd-generation (3G) cellular phone (e.g. One-Segment in Japan), video data is encoded by H.264/AVC, and audio data is encoded by MPEG-2 AAC. These encoded video and audio data are called elementary streams (hereinafter, simply called ES), and both ESs are multiplexed and transmitted in a transport stream described in MPEG-2 systems as a packetized elementary stream packet (hereinafter, simply called PES). In a transport stream, a transport stream packet (hereinafter, simply called a TS packet) is arranged. A TS packet can store attribute information indicating the attribute of a bit stream composing video and audio data, a bit stream, and reference clock information called a program clock reference (hereinafter, simply called PCR) for synchronizing between media such as video and audio data. A TS packet is transmitted wirelessly or through a wire.

PCR is used to control a system time clock (hereinafter, simply called STC) for clock synchronizing with a transmitting side. For example, STC is adjusted by extracting a value obtained by sampling the PCR of a transmitting side at 27 MHz and comparing the obtained value with the count of STC in a receiving side (clock recovery), as disclosed in “Digital Broadcasting Textbook—I (Revised version)” Impress, October 2004, p. 85-87, supervised by Wataru Kameyama & Tsuyoshi Hanamura, showing a basic technology regarding a digital broadcasting system. In a receiving side, when STC counted by a STC counter reaches a presentation time stamp (hereinafter, simply called PTS) included in a TS packet, ES is synchronously reproduced. More specifically, an access unit (hereinafter, simply called AU) corresponding to PTS is presented. Here, an AU is a reproducing unit of ES.

For example, when receiving a transport stream in an environment with a weak electric field, an error may be mixed into a TS packet. When an error occurs in a PTS, the presentation time of a corresponding AU may become indefinite. When presentation time of the AU becomes indefinite, usually, a rendering device does not reproduce the corresponding AU, or reproduces the AU at a local timing in the rendering device without using the PTS. Therefore, an error mixed into the PTS may extremely deteriorate the QoS (quality of service) of content.

Incidentally, a TS header in a TS packet has a bit called a transport error indicator for detecting an error in the TS packet, but this bit does not have an error correcting capability.

### BRIEF SUMMARY OF THE INVENTION

According to an aspect of the invention, there is provided, a contents reproducing apparatus comprising: a clock unit configured to count a system time clock, and output a counter value; a receiving unit configured to receive a packet having an elementary stream containing encoded video data or the encoded audio data, an transport error indicator to be used for detecting an error, and a presentation time stamp, and add a counter value as a receipt time at the time of reception; a correcting unit configured to correct the presentation time stamp by using the receipt time and an interval from reception of a packet to reproduce of a packet, if the error is detected in the packet; a buffer configured to store the elementary stream and presentation time stamp; a decoder configured to decode the encoded video data or the encoded audio data from the elementary stream and obtain video data or audio data, if the counter value reaches the presentation time stamp; and a reproducing unit configured to reproduce the video or audio data.

According to the invention, there is provided a stream reproducing apparatus, which corrects an error occurring in a PTS in a TS packet, and prevents deterioration of QoS.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing a stream reproducing apparatus according to an embodiment of the invention;

FIG. 2 is a diagram showing the structure of a TS packet processed by the stream reproducing apparatus shown in FIG. 1, the structure of a transport stream consisting of the TS packet, and the structure of a PES packet stored in a payload in the TS packet;

FIG. 3A is a diagram showing the structure of a TS header in the TS packet shown in FIG. 2;

FIG. 3B is a diagram showing the structure of an adaptation field in the TS packet shown in FIG. 2;

FIG. 3C is a diagram showing the structure of the PES header shown in FIG. 2; and

FIG. 4 is a flowchart showing the operations of the PTS correcting unit.

### DETAILED DESCRIPTION OF THE INVENTION

Hereinafter, an embodiment of the invention will be explained with reference to the accompanying drawings.

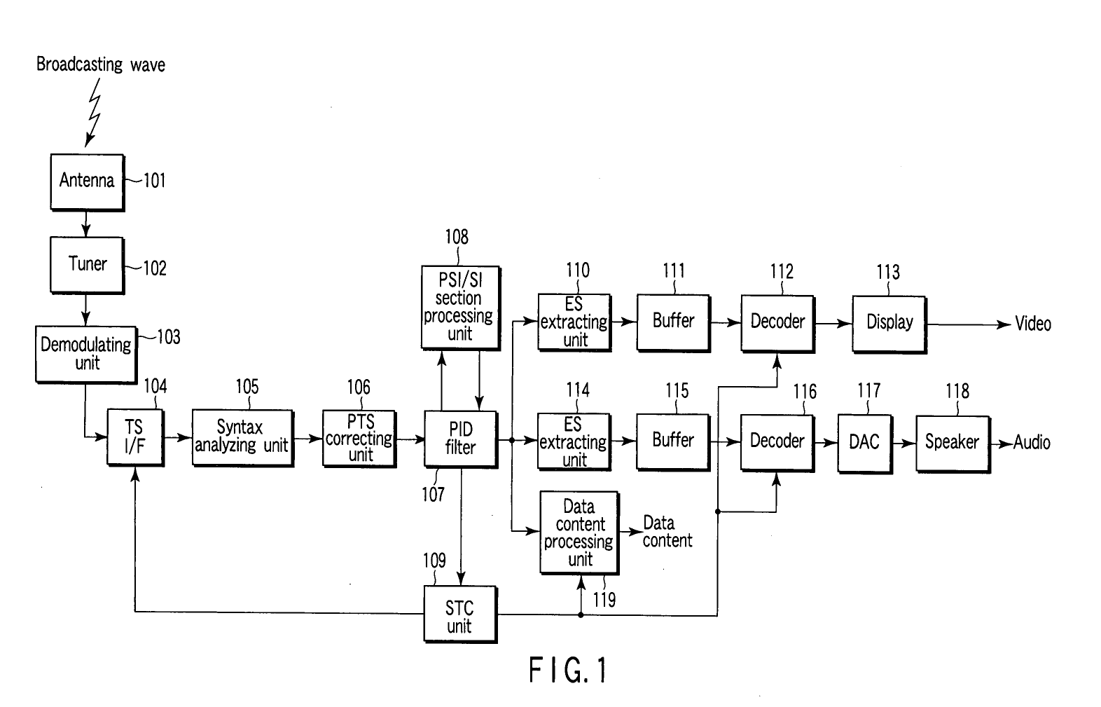

FIG. 1 shows a contents reproducing apparatus according to an embodiment of the invention. The contents reproducing has an antenna 101, a tuner 102, a demodulating unit 103, a TS I/F 104, a syntax analyzing unit 105, a PTS correcting unit 106, a PID filter 107, a PSI/SI section processing unit 108, a STC unit 109, ES extracting units 110 and 114, buffers 111 and 115, decoders 112 and 116, a display 113, a DAC (digital-analog converter) 117, a speaker 118, and a data content processing unit 119.

The antenna 101 receives a broadcasting wave transmitted from a broadcasting station, and transfers the received broadcasting wave to the tuner 102. The tuner 102 selects a designated channel from the broadcasting wave received through the antenna 101. The demodulating unit 103 demodulates a transport stream from a signal transmitted in the channel selected by the tuner 102.

The TS I/F (interface) 104 receives the transport stream demodulated by the demodulating unit 103 in units of TS packets, and transfers the TS packets to the syntax analyzing unit 105 by adding the receipt time. More specifically, the TS I/F 104 adds the STC value obtained from the STC unit 109 when receiving a TS packet, to the corresponding TS packet as a receipt time. The receipt time added to the TS packet will be removed by the PTS correcting unit 106 described later.

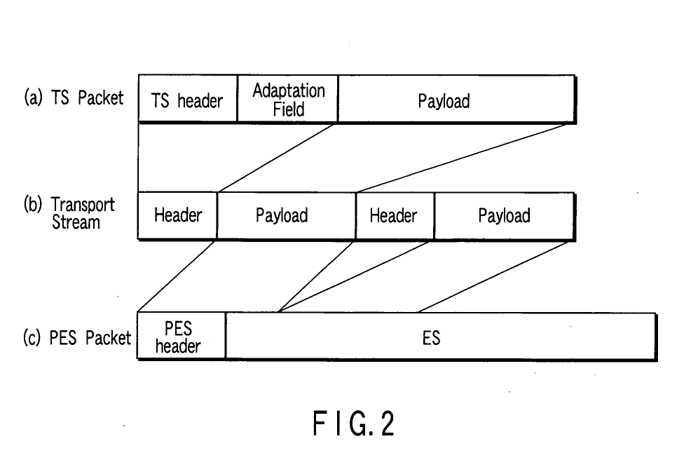

As shown in FIG. 2, a TS packet (a) led by a 4-byte TS header, and configured as a 188-byte fixed length packet consisting of an adaptation field as an optionally settable field and a payload. Also, as shown in FIG. 2, a TS packet is arranged in a transport stream (b). In FIG. 2, a TS header and an adaptation field of the TS packet contained in the transport stream are expressed as a header for the sake of convenience.

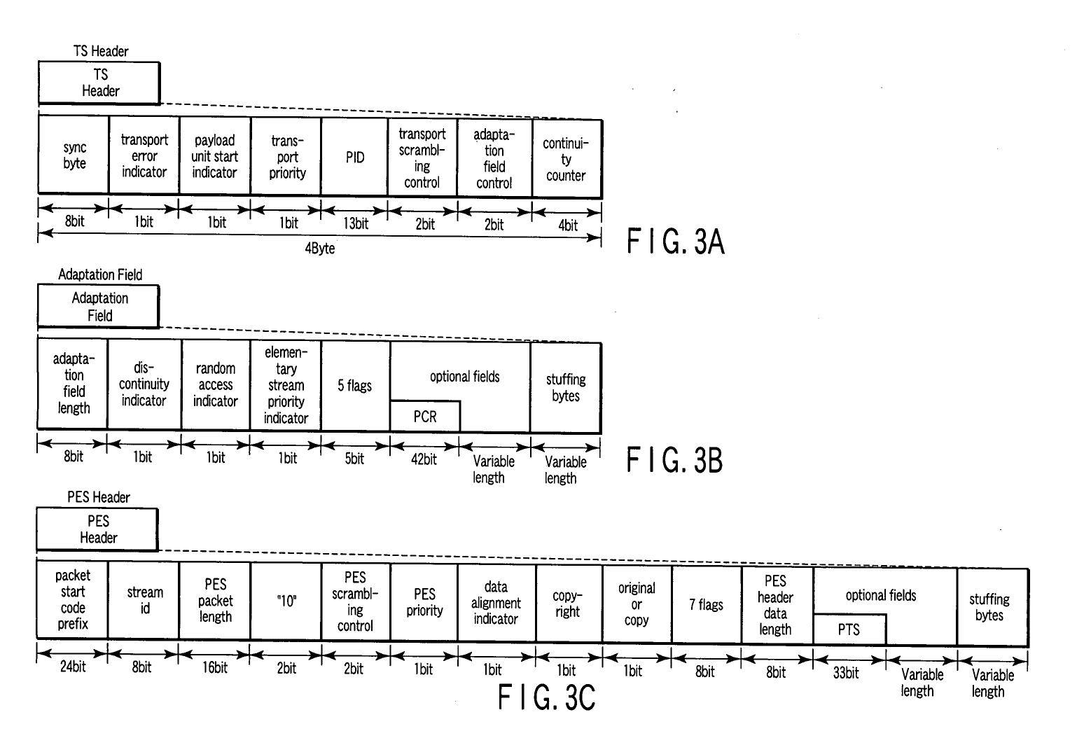

As shown in FIG. 3A, a TS header includes a 13-bit length packet ID (PID), which makes it possible to determine which of the video data and audio data is transmitted by a TS packet. Namely, as the same video data and audio data have the same PID, the ES before being packetized can be restored by using a PID.

Further, a TS header includes a 1-bit transport error indicator which shows whether a TS packet includes an error, and a 2-bit length adaptation field control indicating the presence or absence of an adaptation field or payload. Here, as an adaptation field control, “11” is defined as “an adaptation field exists, and payload exists”, “10” is defined as “an adaptation field exists, and a payload does not exist”, “01” is defined as “an adaptation field does not exist, and a payload exists”, and “00” is defined as “RFU (Reserved for Future Use)”, respectively.

A TS header also has a sync byte indicating the beginning of the TS packet. A TS header also has a payload unit start indicator, which informs the decoder that a new PES packet starts from a payload in the TS packet. A TS header also has a transport priority indicating the importance of the TS packet, and a 2-bit length transport scrambling control indicating the presence or absence of a scramble of a payload in the TS packet. A TS header also has a 4-bit length continuity counter for detecting whether some of TS packets having the same PID are discarded halfway.

As shown in FIG. 3B, an adaptation field has a variable length optional field, and a 42-bit length PCR is included in this optional field. Further, an adaptation field has an 8-bit length adaptation field length, a 1-bit discontinuity indicator indicating the presence or absence of a discontinuity of time base, a random access indicator, an elementary stream priority indicator, 5 flags including a 1-bit PCR flag indicating the presence or absence of PCR in an adaptation field, and variable length stuffing bytes.

As shown in FIG. 2, a payload accommodates part of a PES packet (c), which is packetized by adding a header called a PES header to ES.

As shown in FIG. 3C, a PES header contains the PTS of the first frame in a PES packet in a 33-bit length field. Here, a PES header consists of a 24-bit length packet start prefix, an 8-bit length stream ID, a 16-bit length PES packet length, “10”, a 2-bit length PES scrambling control, a PES priority, a data alignment indicator, a copy right, an original or copy, 7 flags, an 8-bit length PES header length, a variable length optional field to accommodate the PTS, and variable length stuffing bytes.

The syntax analyzing unit 105 analyzes each syntax in the TS header and adaptation field in the TS packet transferred from the TS I/F 104 and extracts the PTS, and transfers the TS packet and the PTS to the PTS correcting unit 106.

The PTS correcting unit 106 separates the receipt time added by the TS I/F 104 from a TS packet. When a TS packet to be processed includes a PTS, the PTS correcting unit 106 transfers the TS packet to the PID filter 107 after correcting the PTS contained in the TS packet. On the other hand, if a TS packet to be processed does not include a PTS, the PTS correcting unit 106 transfers the packet to the PID filter 107.

When an error might be included in the PTS of the TS packet transferred from the syntax analyzing unit 105, the PTS correcting unit 106 corrects the PTS by using initial delay. The initial delay shows time lag between the receipt time of the TS packet including the PTS and the time that an AU (Access Unit) actually is presented, that is, the time lag from the receipt time to the PTS. The PTS correcting unit 106 calculates the initial delay by subtracting the receipt time of the TS packet including the PTS from the PTS. When the transport error indicator in the TS packet to be processed is “1”, an error may be caused in the PTS. Therefore, the PTS correcting unit 106 does not calculate the initial delay from the PTS, and waits for the next opportunity.

After calculating the initial delay, the PTS correcting unit 106 determines that an error may be caused in the TS packet to be processed (a) when the transport error indicator in the TS packet to be processed is “1” and (b) when the absolute value of the difference between the PTS in the TS packet to be processed and the sum PTS′ of the initial delay and the corresponding receipt time of the TS packet is larger than a predetermined threshold value. Here, the threshold value is a 1-frame interval, for example, but is not limited to this.

The PTS correcting unit 106 determines that an error is caused in the PTS, and the PTS correcting unit 106 adjusts the PTS to the sum PTS′ of the receipt time and initial delay. To correct the PTS more exactly, the PTS correcting unit 106 may consider a time interval obtainable from a sampling frequency for a medium such as audio data or vide data. Namely, for the audio data, the PTS correcting unit 106 finely adjusts the sum PTS′ of the receipt time and initial delay to be a multiple of the frame interval calculated from the sampling frequency. For the video data, the PTS correcting unit 106 assumes a fixed frame rate, and finely adjusts the sum PTS′ of the receipt time and initial delay to be a multiple of the frame interval as in the case for the audio data. As described above, PTS can be corrected more exactly by considering a time interval obtainable from the sample frequency for the medium.

The PID filter 107 assigns the TS packet transferred from the PTS correcting unit 106 based on the PID analyzed by the syntax analyzing unit 105. More specifically, by the PSI/SI section processing unit 108 described later, the PID filter 107 sets a value of a PID and a corresponding type of TS packet based on table information called PMT (Program Map Table) given to each program.

In a PMT, a value of a PID corresponds to a type of TS packet, and it is possible to determine that a TS packet having a specific value of a PID is any one of video, audio, section, data content (caption, for example) and PCR. A PCR is contained in an adaptation field in a TS packet, as described above, and may be transmitted together with a payload including video and audio, or may be transmitted alone without being accompanied by a payload. Therefore, a value of one PID may indicate a TS packet including a PCR only, or may indicate a TS packet including both a PCR and a video. If a program being watched is changed by the user's operation, the section processing unit 108 resets the assigning operation of the PID filter 107 by using a new PMT.

When a TS packet includes a section such as PMT, the PID filter 107 transfers the TS packet to the section processing unit 108. When a TS packet includes video data, the PID filter 107 transfers the TS packet to the ES extracting unit 110. When a TS packet includes audio data, the PID filter 107 transfers the TS packet to the ES extracting unit 114. When a TS packet is data content, such as a caption, superimposed character and data carousel, the PID filter 107 transfers the TS packet to the data content processing unit 119. When a TS packet includes a PCR, the PID filter 107 transfers the PCR to the STC unit 109. When the PID of a TS packet is not set, the PID filter 107 abandons the TS packet.

The section processing unit 108 processes a TS packet having a section assigned from PID. A section includes program specific information (PSI) and service information (SI), for example. The above-mentioned PMT is one of PSI. When the TS packet having PMT is assigned by the PID filter 107, the section processing unit 108 resets the assigning operation of the PID filter 107, if necessary. For example, when the TS packet having a PMT after a change of program or a change of version number is assigned by the PID filter 107, the section processing unit 108 resets the assigning operation of the PID filter 107.

The STC unit 109 provides the TS I/F 104 and decoders 112 and 116 with clock information such as the counter value to be used for controlling the TS I/F 104, and decoders 112 and 116. When a PCR is input from the PID filter 107, the STC unit 109 performs clock recovery. More specifically, the operating frequency of STC is controlled to decrease the difference between the counter value of STC and PCR.

The ES extracting unit 110 extracts the ES for videos from a TS packet having the ES assigned by the PID filter 107, and buffers the ES in the buffer 111. The decoder 112 acquires ES stored in the buffer 111, decodes the ES, and obtains video data. When a value of the STC from the STC unit 109 reaches the PTS of the ES, the decoded video data is reproduced by the display 113.

The ES extracting unit 114 extracts the ES for an audio from a TS packet having the ES assigned by the PID filter 107, and buffers the ES in the buffer 115. The decoder 116 acquires the ES stored in the buffer 115, decodes ES, and obtains audio data. When a value of an STC from the STC unit 109 reaches the PTS of the ES, the decoded audio data is converted from digital to analog by a digital-analog converter (DAC) 120, and reproduced through a speaker 118.

The data content processing unit 119 performs processing for reproducing the data content assigned from the PID filter 107. For example, the data content processing unit 119 reproduces subtitles or superimposed characters.

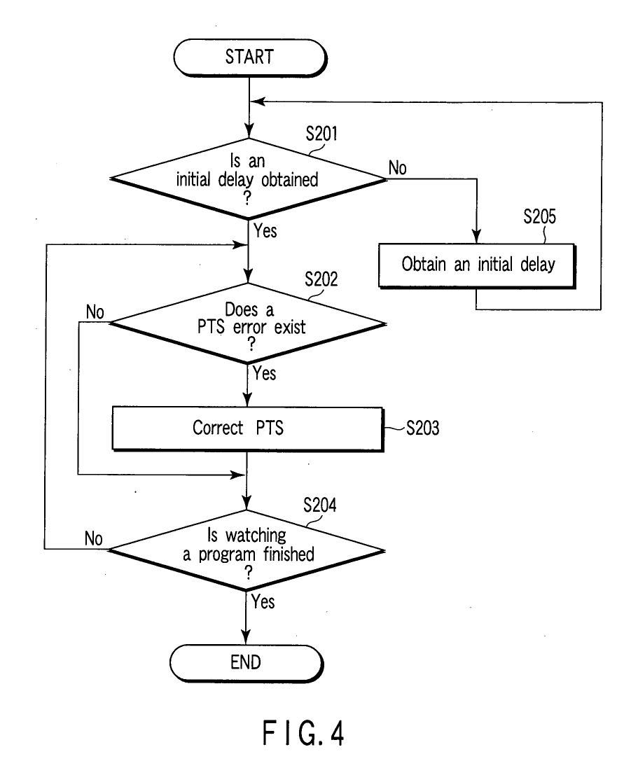

Hereinafter, explanation will be given on the operations of the PTS correcting unit 106 by using the flowchart shown in FIG. 4.

First, when a TS packet having a PTS is transferred from the syntax analyzing unit 105, the PTS correcting unit 106 confirms whether an initial delay has been obtained or not (step S201). More specifically, the PTS correcting unit prepares a flag indicating that an initial delay has already obtained or not, and refers to this flag.

When an initial delay has already obtained, the PTS correcting unit 106 determines whether an error is included in PTS in a TS packet to be processed (step S202). More specifically, when a transport error indicator in the TS packet is “1”, the PTS correcting unit 106 determines that an error is included in the PTS. Further, when the difference between PTS and the sum PTS′ of the initial delay and the receipt time added by the TS I/F 104 is larger than a threshold value, the PTS correcting unit 106 also determines that an error is included in the PTS. Here, the threshold value is 1-frame interval, for example, but is not limited to this.

When an error is included in a PTS in a TS packet to be processed (step S202), the PTS correcting unit corrects the PTS, and the processing goes to step S204 (step S203). More specifically, the PTS correcting unit 106 corrects the PTS in a TS packet to be processed to the sum PTS′ of the receipt time and initial delay. As described above, to correct the PTS more exactly, the PTS correcting unit 106 may consider a time interval obtained from the sampling frequency for the medium. Namely, the sum PTS′ of the receipt time and initial delay may be finely adjusted to be the same as an integer multiple of a frame interval. If an error is not included in the PTS (step S202), step S203 is omitted, and the operation goes to step S204.

In step S204, the PTS correcting unit 106 confirms whether watching of a program is finished or not. Namely, if the next TS packet to be processed does not exist, the PTS correcting unit 106 determines that watching of a program is finished, and stops the operation. Contrarily, when the next TS packet to be processed exists, the PTS correcting unit 106 returns to step S202 to process the next TS packet.

If an initial delay has not yet obtained (step S201), the PTS correcting unit 106 obtains an initial delay (step S205). More specifically, when a transport error indicator is not “1”, the PTS correcting unit 106 stores a value obtained by subtracting the receipt time from the PTS in a TS packet as an initial delay, and returns to step S201 to process the next TS packet. When a transport error indicator is “1”, an error may be caused in the PTS, and the PTS correcting unit 106 does not calculate an initial delay.

As described hereinbefore, in this embodiment, a PTS that may include an error is corrected by using an initial delay calculated from the difference between a receipt time of a TS packet including PTS and the corresponding PTS. Therefore, according to this embodiment, the PTS that may include an error is corrected, and a presenting time of an AU does not become indefinite, and deterioration of QoS can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A contents reproducing apparatus comprising:
a clock unit configured to count a system time clock, and output a counter value;
a receiving unit configured to receive a packet having an elementary stream containing encoded video data or the encoded audio data, an transport error indicator to be used for detecting an error, and a presentation time stamp, and add a counter value as a receipt time at the time of reception;
a correcting unit configured to correct the presentation time stamp by using the receipt time and an interval from reception of a packet to reproduce of a packet, if the error is detected in the packet;
a buffer configured to store the elementary stream and presentation time stamp;
a decoder configured to decode the encoded video data or the encoded audio data from the elementary stream and obtain video data or audio data, if the counter value reaches the presentation time stamp; and
a reproducing unit configured to reproduce the video or audio data.

2. The apparatus according to claim 1, wherein the correcting unit is configured to adjust the presentation time stamp to a sum of the receipt time and initial delay, if the error is detected in the packet.

3. The apparatus according to claim 1, wherein the correcting unit is configured to adjust the presentation time stamp to a value which is a multiple of a frame interval of the video or audio data, and closest to a sum of the receiving time and initial delay, if the error is detected in the packet.

4. The apparatus according to claim 1, wherein the correcting unit is configured to detect the error in the packet, if an absolute value of the difference between a sum of the receipt time and initial delay and the presentation time stamp is larger than a threshold value.

5. The apparatus according to claim 4, wherein the threshold value is a 1-frame interval.

6. The apparatus according to claim 1, wherein the correcting unit is configured to detect the error in the packet by referring to a value of the transport error indicator.

7. The apparatus according to claim 1, wherein the correcting unit is configured to previously calculate the initial delay from the difference between a second presentation time stamp of a second packet not including an error received before the packet and a second receipt time of the second packet.

8. A contents reproducing apparatus comprising:
a clock unit configured to count a system clock, and output a counter value;
a receiving unit configured to receive a packet having an stream containing encoded video data or the encoded audio data, an error indicator to be used for detecting an error, and a presentation time, and add a counter value as a receipt time at the time of reception;
a correcting unit configured to correct the presentation time by using the receipt time and an interval from reception of a packet to reproduce of a packet, if the error is detected in the packet;
a buffer configured to store the stream and presentation time;
a decoder configured to decode the encoded video data or the encoded audio data from the stream and obtain video data or audio data, if the counted value reaches the presentation time; and
a reproducing unit configured to reproduce the video or audio data.

9. The apparatus according to claim 8, wherein the correcting unit is configured to adjust the presentation time to a sum of the receipt time and initial delay, if the error is detected in the packet.

10. The apparatus according to claim 8, wherein the correcting unit is configured to adjust the presentation time to a value which is a multiple of a frame interval of the video or audio data, and closest to a sum of the receipt time and initial delay, if the error is detected in the packet.

11. The apparatus according to claim 8, wherein the correcting unit is configured to detect the error in the packet, if an absolute value of the difference between a sum of the receipt time and initial delay and the presentation time is larger than a threshold value.

12. The apparatus according to claim 11, wherein the threshold value is a 1-frame interval.

13. The apparatus according to claim 8, wherein the correcting unit is configured to detect the error in the packet by referring to a value of the error indicator.

14. The apparatus according to claim 8, wherein the correcting unit is configured to previously calculate the initial delay from the difference between a second presentation time of a second packet not including an error received before the packet and a second receiving time of the second packet.

15. A contents reproducing apparatus comprising:
a clock unit configured to generate a system clock;
a receiving unit configured to receive first packets containing at least part of second packet containing encoded video data or the encoded audio data, an error indicator to be used for detecting an error, and a presentation time, and add a counter value as a receipt time at the time of reception;
a correcting unit configured to correct the presentation time based on the receipt time and an interval from receipt time of the first packet to reproduction time of the second packet, if the error is detected in the first packet;
a buffer configured to store the second packet and presentation time;
a video decoder configured to decode the encoded video data contained in the second packet and obtain video data, if the system clock reaches the presentation time;
an audio decoder configured to decode the encoded audio data contained in the second packet and obtain audio data, if the system clock reaches the presentation time; and
a reproducing unit configured to reproduce the video and audio data.

16. The apparatus according to claim 15, wherein the correcting unit is configured to adjust the presentation time to a sum of the receipt time and initial delay, if the error is detected in the first packet.

17. The apparatus according to claim 15, wherein the correcting unit is configured to adjust the presentation time to a value which is a multiple of a frame interval of the video data or the audio data, and closest to a sum of the receipt time and initial delay, if the error is detected in the first packet.

18. The apparatus according to claim 15, wherein the correcting unit is configured to detect the error in the first packet, if an absolute value of the difference between a sum of the receipt time and initial delay and the presentation time is larger than a threshold value.

19. The apparatus according to claim 18, wherein the threshold value is a 1-frame interval.

20. The apparatus according to claim 15, wherein the correcting unit is configured to detect the error in the first packet by referring to a value of the error indicator.
